(19) United States
(12) Patent Application Publication
(10) Pub. No.: US 2011/0062901 A1
(43) Pub. Date: Mar. 17, 2011

(54) Arrangement of Stator Modules in a Linear Motor

(75) Inventor: Sven Busch, Dortmund (DE)

(73) Assignee: Dorma GmbH + Co. KG, Ennepetal (DE)

(21) Appl. No.: 12/673,710

(22) PCT Filed: Jul. 30, 2008
(86) PCT No.: PCT/EP08/06271

§ 371 Date: Feb. 16, 2010

(30) Foreign Application Priority Data
Aug. 16, 2007 (DE) 10 2007 038 845.6

(51) Int. Cl. H02K 41/02; H02P 7/285

(52) U.S. Cl. 318/135; 310/12.19

(57) ABSTRACT

A linear motor is disclosed, which has a stator and at least one rotor, the stator having at least two stator modules. Each stator module has a coil arrangement and, seen in longitudinal extension of the respective stator module, at least at one end, a displacement sensor. Each stator module is disposed along a travel path of the respective rotor in an area of the respective stator module. Each displacement sensor has a detection range, within which it can detect a rotor, as long as the latter is located at least partially in the detection range. Each coil arrangement has an interaction range, within which, in case of energizing, the coil arrangement comes into interaction with the rotor and urges the latter in a driving direction, as long as the rotor is located with at least one portion in the interaction range. The at least two stator modules and the at least one rotor are disposed such that, at all times, a portion of the at least one rotor is located at least in the detection range of a displacement sensor and another portion of this rotor at least in the interaction range of a coil arrangement of the at least two stator modules.

### FIELD OF THE INVENTION

The invention relates to an arrangement of stator modules in a linear motor.

### BACKGROUND OF THE INVENTION

Linear motors are very well known. In order to be able to determine a position of a rotor, the linear motor stators usually have displacement sensors in the shape of Hall sensors. Usually, the Hall sensors are incorporated into the linear motor stator such that they are disposed between coils of such a stator. This is disadvantageous in that the Hall sensors need to be shielded against magnetic influences. These magnetic influences are generated on account of current-carrying coil windings in the stator and on account of a possibly existing magnetic keeper of the stator. The challenge is now to assure that the displacement sensors are able to continue to detect a rotor of a linear motor. Thereby, the structure of such a stator becomes very expensive.

### SUMMARY OF THE INVENTION

One object of the invention is to reduce or to eliminate the above disadvantages.

In an inventive linear motor, comprising a stator and at least one rotor, the stator has at least two stator modules. Each stator module has a coil arrangement and, seen in a longitudinal extension of the respective stator module, at least at one end of the coil arrangement, a displacement sensor. This means, the displacement sensors are configured separately from the respective coil arrangements. This brings about advantages in manufacturing, as the coil arrangement and the displacement sensors can be manufactured and tested independently from each other. In addition, a magnetic shielding of the displacement sensors is easier to accomplish, because it does not need to be provided within the coil arrangement. The displacement sensors and the coil arrangement can be fitted into a housing, which itself provides said shielding, namely from magnetic influences of the coil arrangement and, if applicable, from possible influences of a coil arrangement of another stator module. Each stator module is disposed along a travel path of the respective rotor in an area of the respective stator module. Each displacement sensor has a detection range, within which the displacement sensor can detect the rotor, as long as the rotor has at least one portion located in the detection range. Each coil arrangement has an interaction range, within which, in case of energizing, the coil arrangement comes into interaction with the rotor and urges the latter in a driving direction, as long as the rotor ihas at least one portion located in the interaction range. The at least two stator modules and the at least one rotor are disposed such that, at all times, a portion of the at least one rotor is located in the detection range of at least one displacement sensor and another portion of this rotor in the interaction range of at least one coil arrangement of the at least two stator modules. It is thereby guaranteed that a position of the at least one rotor can be determined any time and that the rotor can be moved any time in a driving direction by means of the stator.

Preferably, two directly adjacently disposed stator modules of the at least two stator modules, with regard to an orientation of their displacement sensors, are disposed with regard to the respective other directly adjacently disposed stator module, according to a length of the at least one rotor, according to a travel path of the at least one rotor, and according to a predetermined characteristic of a driving force of the linear motor depending on the travel path of the rotor. It is furthermore preferred that the two directly adjacently disposed stator modules are disposed with their respective displacement sensors facing each other.

Preferably, two directly adjacently disposed stator modules of the at least two stator modules have a distance to each other according to the length of the at least one rotor, according to the travel path of the at least one rotor, and according to the predetermined characteristic of the driving force of the linear motor depending on the travel path of the at least one rotor.

Preferably the displacement sensors are formed by means of Hall sensors.

Furthermore, the linear motor has preferably a control circuit, which is coupled to the at least two stator modules and adapted to pick up, respectively to read detection signals of the displacement sensors, to determine, based on the detection signals from the displacement sensors, a position of the at least one rotor with regard to the stator, and to control the at least two stator modules according to the determined position of the at least one rotor. It is thereby for example possible to determine when the rotor is reaching a terminal position and, if required, to switch-off the stator.

It is furthermore preferred that the control circuit is adapted to switch-off at least one coil arrangement of one of the at least two stator modules, if the control circuit determines that the determined position of the respective rotor corresponds to falling below a predetermined first penetration measure of this rotor into a predetermined section of the interaction range of the one coil arrangement. It is thus checked in which area of the interaction range of the respective coil arrangement the rotor penetrated. This is required in order to be able to prevent the respective coil arrangement for example from being switched off, if the rotor, coming from a terminal position, is supposed to enter the interaction range of this respective coil arrangement and to pass through the interaction range. Switching-off coil arrangements has the advantage of wasting as little energy as possible.

In addition, the control circuit may be adapted to switch-off at least one coil arrangement of one of the at least two stator modules, if the control circuit determines that the determined position of the rotor corresponds to a predetermined terminal position of the at least one rotor. This is required to guarantee the terminal positioning of the at least one rotor such that the respective coil arrangement, after an additional switching-on, can still drive, respectively move the at least one rotor, for example in the opposite direction.

In addition or as an alternative, the control circuit may be furthermore adapted to switch-on additionally, i.e. to energize, at least one coil arrangement of one of the at least two stator modules, if the control circuit determines that the determined position of the respective rotor corresponds to a predetermined second penetration measure of the at least one rotor into the interaction range of the one coil arrangement or to exceeding this second penetration measure. This is in particular practical, if the at least one rotor, coming from another stator module, penetrates the interaction range of the one coil arrangement and an immediate additional switching-on of the other coil arrangement is not desired. This measure serves the purpose that the stator does not function unnecessarily while idling and thus wasting energy.

According to the invention, the first and the second penetration measures can be equal. Thus it is possible to additionally switch-on, respectively to switch-off the respective coil arrangement at essentially the one and same position of the at least one rotor with regard to the respective coil arrangement.

### BRIEF DESCRIPTION OF DRAWING FIGURES

Further features and advantages of the invention will become apparent from the following description of preferred embodiments, in which:

FIGS. 1A to 1F are plan views of an arrangement of stator modules and respective diagrams of a driving force F of the linear motor depending on a travel distance s of the rotor according to a first embodiment of the invention,

FIGS. 2A and 2B are plan views of an arrangement of stator modules and respective diagrams of a driving force F of the linear motor depending on a travel distance s of the rotor according to a second embodiment of the invention,

FIGS. 3A and 3B are plan views of an arrangement of stator modules and respective diagrams of a driving force F of the linear motor depending on a travel distance s of the rotor according to a third embodiment of the invention, and

FIGS. 4A and 4B are plan views of an arrangement of stator modules and respective diagrams of a driving force F of the linear motor depending on a travel distance s of the rotor according to a fourth embodiment of the invention.

### DETAILED DESCRIPTION OF THE EMBODIMENTS

A linear motor 1 has a rotor 2 and a stator 10.

The rotor 2 is preferably formed by a row of permanent magnets, which extends along a travel path of a panel to be moved 3 by the rotor 2. Preferably, in case of directly adjacent permanent magnets, the one with a north pole end and the other one with a south pole end are disposed facing the stator 10 of the linear motor 1. As an alternative, the rotor 2 may be formed by a magnetizable part. The rotor 2 is preferably stationarily disposed on the panel to be moved 3 along the travel path or on a suspension thereof. If the panel to be moved 3 is suspended by means of carriages, which are guided in one or more guiding rails, the rotor 2 can be stationarily mounted at a surface of the respective carriage facing the stator 10 or on a surface of a profile connecting the carriages, which surface faces the stator 10.

The stator 10 is mounted stationarily at a carrying profile for example or accommodated therein. The stator 10 has at least two stator modules 11, which have respectively at least one displacement sensor 12, which, seen in longitudinal extension of the associated stator module 11, is configured or disposed at an end of the latter. Furthermore, each stator module 11 has a coil arrangement 13, which, seen in longitudinal extension of the respective stator module 11, is disposed adjoining the respective at least one displacement sensor 12. The coil arrangements 13, 13, when seen in longitudinal extension of the respective stator module 11, are respectively formed by means of a row of consecutively disposed coils, which are wired with winding wire and connected to each other according to a wiring diagram. Preferably, the displacement sensors 12 are respectively formed by means of Hall sensors.

The term interaction range indicates a spatial extension of an alternating magnetic field, within which the alternating magnetic field reaches a driving interaction effect with the rotor 2, as soon as the rotor is at least partially located within this spatial extension. The interaction range may refer to individual coils or likewise to an entire coil arrangement 13 of a stator module 11. The alternating magnetic field is generated by energizing the stator module 11, i.e. its coil arrangement 13 and thus its individual coils.

The term detection range identifies a spatial extension of an area, within which a displacement sensor 12 is capable of detecting a rotor 2, as long as the latter is located at least partially within this spatial extension of an area.

In the Figures, only the parts relevant for the invention are illustrated. The rotor 2, respectively the panel to be moved 3 are shown in the Figures in a first maximally possible terminal position of the rotor 2. The reference numerals 2′ and 3′ indicate the panel to be moved 3, respectively the rotor 2 in a second maximally possible terminal position of the rotor 2. A distance between the terminal positions defines a maximum travel distance covered for the respective rotor 2. The rotor 2 needs to fulfil the following conditions:
length of the rotor 2>maximum of distances between interaction ranges of coil arrangements 13 of respectively two directly adjacently disposed stator modules 11; and
length of the rotor 2>maximum of distances between detection ranges of respectively two directly adjacently disposed displacement sensors 12.

Maximally possible terminal positions of the rotor 2 can be set, as long as a travel path of the rotor 2 is not configured to revolve. A respective maximally possible terminal position of the rotor 2 then refers to a respective stator module 11, which is only directly adjacently disposed to another stator module 11. This respective stator module 11 thus represents a terminal stator module 11 with regard to the stator 10. If a terminal coil arrangement 13 is disposed at an end of such a terminal stator module 11, which end simultaneously forms an end of the stator 10, the rotor 2, with regard to this terminal stator module 11, is positioned in an associated maximally possible terminal position, such that the rotor 2 is disposed to extend from a terminal displacement sensor 12, which is directly adjacent to the terminal coil arrangement 13, in the direction of the terminal coil arrangement 13 and is still located just within the detection range of this terminal displacement sensor 12. If a terminal displacement sensor 12 is disposed at said end of such a terminal stator module 11, the rotor 2 is positioned with regard to the terminal stator module 11 in an associated maximally possible terminal position such that it is disposed to extend from a terminal coil arrangement 13, which is directly adjacent to the terminal displacement sensor 12, in the direction of the terminal displacement sensor 12 and is still located just within the interaction range of this terminal coil arrangement 13.

A distance between maximally possible terminal positions thus represents a maximally possible travel distance covered, within which the rotor 2 and thus the panel to be moved 3 can be moved, without the rotor 2 leaving a displacement sensor detection range and/or leaving the driving interaction effect of the stator 10.

In the event of a revolving travel path, as may be the case with circular sliding doors for example, no maximum terminal positions are possible. Different solutions need to be provided for this case. For example terminal positions can be realized by means of limit stop switches or an evaluation of the position of the rotor 2, respectively of the panel to be moved 3, positions determined for example by means of the displacement sensors 12, and by means of a subsequently occurring corresponding activation of the linear motor 1.

In the Figures, a driving and thus a movement of the respectively illustrated rotor 2 take place from the left to the right sides.

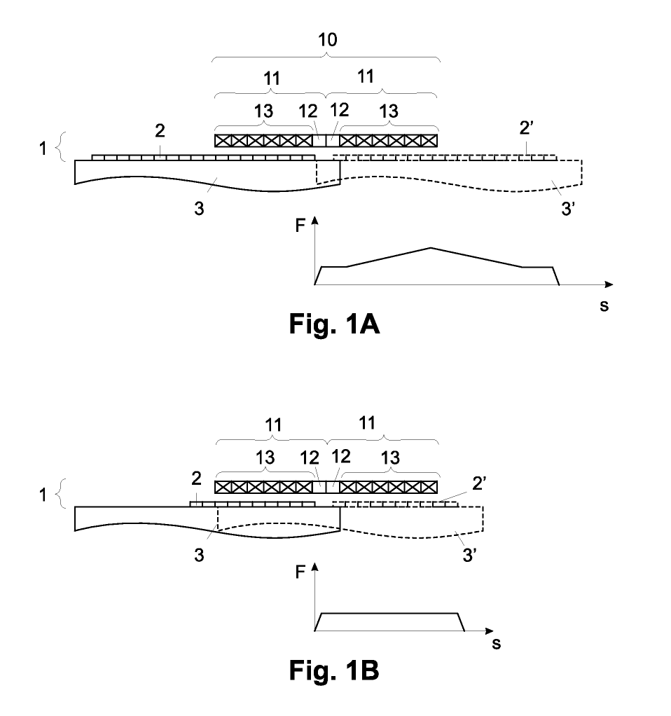

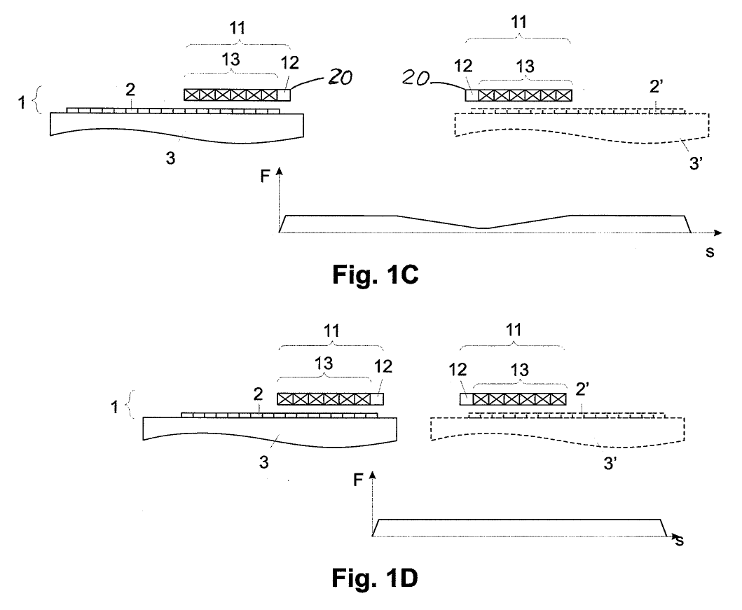

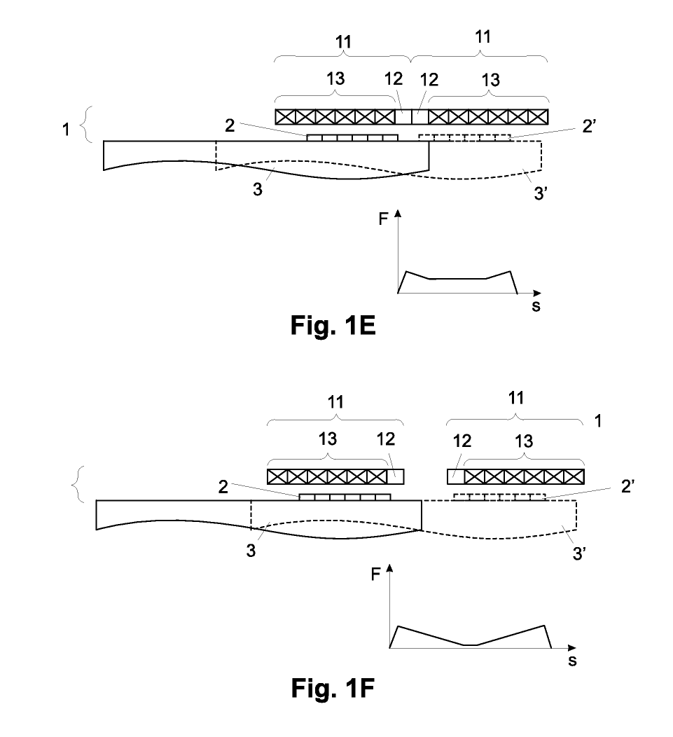

According to a first embodiment of the invention shown in FIG. 1A, stator modules 11, 11 preferably each have a coil arrangement 13 and a displacement sensor 12 and, for illustration purposes, the stator modules 11, 11 have the same structure. The displacement sensors 12, 12 are configured at ends of the stator modules 11, 11 facing each other. The stator modules 11, 11 extend respectively along an area of an exemplary linear travel path of the panel to be moved 3 in the area of the respective stator module 11. In the arrangement shown, the stator modules 11, 11 abut against each other, i.e. they have a very small distance to each other or they do not have any distance at all. Preferably, a shape of a respective stator module 11, seen in longitudinal extension, follows a course of the travel path of the panel to be moved 3 in the area of the respective stator module 11.

A diagram, illustrated on the bottom of FIG. 1A, diagrammatically shows a characteristic of a driving force F of the linear motor 1 depending on a travel distance covered s of the rotor 2.

At the beginning of a movement of the rotor 2, i.e. in the illustrated first terminal position, the rotor 2 is in interaction with all coils of the left coil arrangement 13.

Under the condition that the coil arrangements 13, 13, or initially only the left coil arrangement 13, are continuously energized, during a movement of the rotor 2 to the right side in FIG. 1A, the driving force F of the linear motor 1 initially rises to a force, which all coils of the left coil arrangement 13 can exert on the rotor 2, as long as the rotor is located in interaction ranges of all these coils.

Thereupon, the driving force F of the linear motor 1 remains constant up to a position of the rotor 2 shortly before the right coil arrangement 13 reaches interaction with the rotor 2, because the rotor 2 has a length which is longer or equal to a sum of a length of the left stator module 11 and the right displacement sensor 12.

If the rotor 2 enters the interaction range of the right coil arrangement 13, the alternating magnetic field in the coils of the right coil arrangement 13, which are in interaction with the rotor 2, intensifies the driving force F of the left coil arrangement 13, as long as the rotor 2 is still in the interaction ranges of all the coils of the left coil arrangement 13. This means the driving force F of the linear motor increases with the continuous movement of the rotor 2.

Shortly before the rotor 2 starts to leave interaction ranges of coils of the left coil arrangement 13, i.e. moving away from the first coil on the left of the left coil arrangement 13 in FIG. 1A, a maximum driving force F of the linear motor 1 is reached. On account of the length of the rotor 2 illustrated in FIG. 1A, the rotor 2 is already in the interaction range of all the coils of the right coil arrangement 13. With a continuous movement, the rotor 2 leaves interaction ranges of more and more coils of the left coil arrangement 13, resulting in a reduction of the driving force F of the linear motor 1. When the rotor 2 leaves the interaction range of the left coil arrangement 13, the driving force F of the linear motor 1 remains constant, because the rotor 2′ is already in the interaction ranges of all the coils of the right coil arrangement 13.

The arrangement shown in FIG. 1A thus results in a symmetrically driving force characteristic over the maximally possible travel path, wherein the driving force F of the linear motor 1 and thus the speed of the rotor 2 increases over almost half of the travel path, and subsequently drops.

FIG. 1B shows the arrangement of FIG. 1A with the difference that the rotor 2 has a length which is equal to a sum of the length of the left stator module 11 and the length of the displacement sensor 12 of the right stator module 11. This means that, as soon as the rotor 2 leaves interaction ranges of coils of the left coil arrangement 13, the rotor 2 enters, to the same extent, interaction ranges of coils of the right coil arrangement 13. Thus, in the transition area between the coil arrangements 13, an almost constant characteristic of the driving force F of the linear motor 1 is achievable, resulting, over the entire travel path of the rotor 2, in an almost constant characteristic of the driving force F of the linear motor 1. Compared to the arrangement of FIG. 1A, the maximally possible travel path of the arrangement of FIG. 1B is comparatively shorter.

FIG. 1C shows the arrangement of FIG. 1A with the difference that the stator modules 11 are disposed at a distance to each other. A maximum distance between the stator modules 11, 11 is determined by the necessity for the rotor 2 to be located at any time in the interaction range of at least one of the coil arrangements 13, 13 and in the detection range of at least one of the displacement sensors 12, 12. Upon moving, initially the rotor 2 remains in the interaction range of all coils of the left coil arrangement 13. Past a predetermined travel distance covered, the rotor 2 gradually leaves interaction ranges of coils of the left coil arrangement 13, but is not yet located the interaction range of the right coil arrangement 13. With the rotor 2 continuously moving, this results in a drop of the driving force F of the linear motor 1. Shortly before the rotor 2 leaves the interaction range of the left coil arrangement 13, the rotor 2 enters the interaction range of the right coil arrangement 13. In this phase of the movement, the driving force F remains almost constant. With a continuous movement, the rotor 2 now leaves the interaction range of the left coil arrangement 13 and enters interaction ranges of more and more coils of the right coil arrangement 13, which results in an increase of the driving force F of the linear motor 1. When the rotor 2 is in the interaction ranges of all coils of the right coil arrangement 13, the driving force F of the linear motor 1 remains constant, with a continuous movement of the rotor 2.

The arrangement shown in FIG. 1C thus results again in a symmetrical driving force characteristic over the maximally possible travel path, wherein the driving force F of the linear motor 1, and thus the speed of the rotor 2, initially are essentially constant up to almost half of the travel path, subsequently drop, increase again and are constant again in a last portion of the travel path. A comparatively maximum travel path can be realized with such an arrangement.

FIG. 1D is a combination of the arrangements illustrated in FIGS. 1B and 10. This means, the stator modules 11 have a distance to each other. The rotor 2 has a length which is equal to a sum of the length of the left stator module 11, a distance of the stator modules 11, 11 to each other and the length of the displacement sensor 12 of the right stator module 11. Thereby an almost constant characteristic of the driving force F of the linear motor 1 can be achieved analogously to the arrangement according to FIG. 1B. However, the maximally possible travel path of the arrangement of FIG. 1D is comparatively longer, when compared to the arrangement of FIG. 1B.

FIG. 1E shows the arrangement of FIG. 1A with the difference that the rotor 2 has such a length that the rotor 2 is completely received in the interaction range of the left coil arrangement 13 and in the detection range of the left displacement sensor 12. This means that, with the movement starting, the rotor 2 already leaves interaction ranges of coils of the left coil arrangement 13, although the rotor 2 is not yet located in the interaction range of the right coil arrangement 13. Thus, as long as the rotor 2 is not located in the interaction range of the right coil arrangement 13, the driving force F of the linear motor 1 drops. When the rotor 2 enters the interaction range of the right coil arrangement 13, the driving force F of the linear motor 1 essentially remains constant as long as the rotor 2 is still located in the interaction range of the left coil arrangement 13. When the rotor 2 leaves the interaction range of the left coil arrangement 13, this will lead to an increase in the driving force F of the linear motor 1. This allows for an operation in which the driving force F of the linear motor 1 and thus the speed of the rotor 2 are at maximum with regard to a maximally possible travel path at the start and at the end, and are slower in an intermediate portion of the travel path, and are almost constant over a predetermined travel distance covered.

FIG. 1F shows the arrangement of FIG. 1E with the difference that the stator modules 11, 11 are disposed at a distance to each other. The driving force drops to a minimum driving force F of the linear motor 1 which is lower than the minimum driving force F in the arrangement shown in FIG. 1E. However, the driving force F of the linear motor 1 remains constant over a shorter travel distance covered than in the arrangement shown in FIG. 1E and subsequently increases again. This means the distance between the stator modules 11, 11 determines the minimum driving force F of the linear motor 1 as well as the consistency thereof with regard to the maximally possible travel path of the rotor 2.

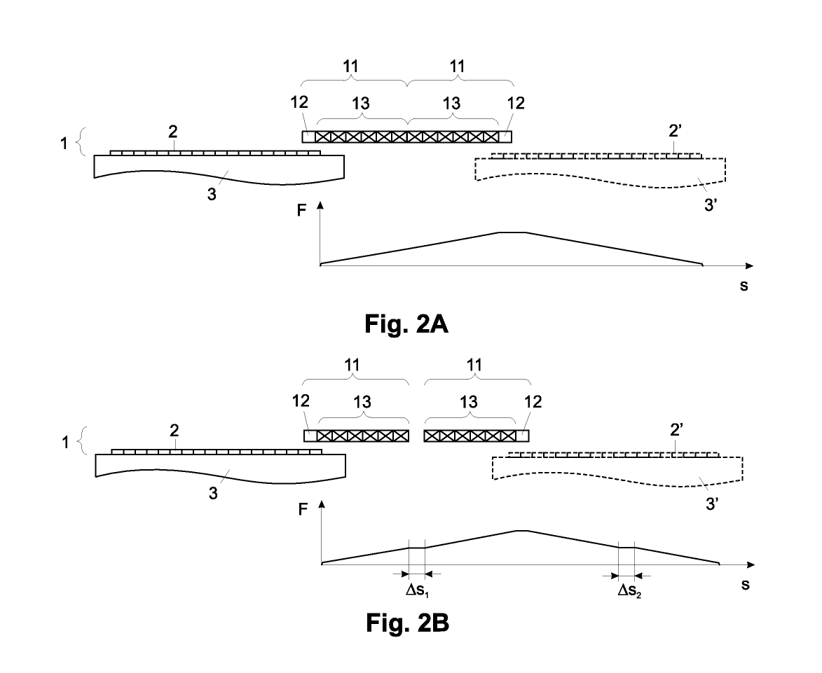

An arrangement shown in FIG. 2A according to a second embodiment of the invention differs from the arrangement shown in FIG. 1A in that the displacement sensors 12, 12 are configured at ends of the stator modules 11, 11 facing away from each other. As the stator modules 11, 11, practically do not have any distance to each other, the stator modules 11, 11 virtually form a single stator module 11, which, at both ends, has respectively one displacement sensor 12 with a coil arrangement 13 disposed therebetween.

When the rotor 2 begins to move, it gradually enters more and more interaction ranges of coils of initially the left and then also the right coil arrangement 13, 13, which results in an increase of the driving force F of the linear motor 1 and thus of the speed of the rotor 2. Thereupon, as long as the rotor 2 is located in the interaction range of all coils of both the left and the right coil arrangement 13, 13, the driving force F of the linear motor 1 remains almost constant. From a predetermined travel distance covered on, the rotor 2 starts to leave interaction ranges of coils of initially the left and thereupon also of the right coil arrangements 13, which results in a drop of the driving force F of the linear motor 1.

In the arrangement illustrated in FIG. 2A, the initial and terminal driving force F, with regard to the travel distance covered s of the rotor 2, correspond to a driving force F, which is generated on account of an interaction of only one of the coil arrangements 13 with a part of the rotor 2, which is necessarily in interaction with the coil. The length of the rotor 2 has an influence on the duration of the consistency of the maximally achievable driving force F of the linear motor 1 with regard to the travel distance covered s. Thus, in the arrangement shown in FIG. 2A, seen over the maximally possible travel path, a symmetric driving force characteristic is the result.

FIG. 2B shows the arrangement of FIG. 2A with the difference that the stator modules 11, 11 are disposed at a distance to each other. The distance between the stator modules 11, 11 has an influence on the characteristic of the driving force F of the linear motor 1 depending on the travel distance covered s of the rotor 2 in such a way, that the driving force F of the linear motor 1 is constant as long as the rotor 2 is located within interaction ranges of all coils of the left coil arrangement 13, but not yet in the interaction range of the right coil arrangement 13. The same applies in the case where the rotor 2, during its movement, is no longer located in the interaction range of the left coil arrangement 13, but within the interaction ranges of all coils of the right coil arrangement 13. According to the diagram in FIG. 2B, this means, respective rising and falling curve sections of the driving force F of the linear motor 1, depending on the travel distance covered s of the rotor 2, have sections with a constant driving force F respectively over a predetermined section Δs₁, or Δs₂ of the travel distance covered s. The sections Δs₁, Δs₂ are determined by means of the distance of the stator modules 11, 11 to each other. This means the sections Δs₁, Δs₂ increase with an increasing distance between the stator modules 11, 11.

The driving force characteristic is symmetric, again with regard to a maximally possible travel path.

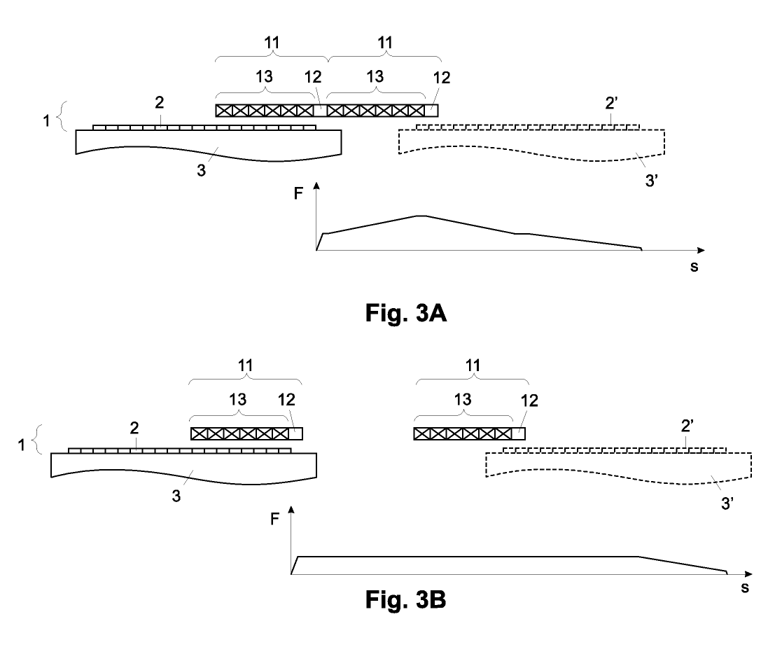

An arrangement according to a third embodiment of the invention shown in FIG. 3A differs from the arrangement shown in FIG. 1A in that the right stator module 11 is disposed rotated about 180° such that the left stator module 11, with its displacement sensor side end, is disposed to face a coil side end of the right coil arrangement 13.

When the rotor 2 starts to move, all coils of the left coil arrangement 13 are in interaction with the rotor 2, which results in the increase in driving force F of the linear motor 1 illustrated in the diagram in FIG. 3A. As long as the rotor 2 is not yet located in the interaction range of the right coil arrangement 13, the driving force F remains essentially constant. When the rotor 2 enters the interaction range of the right coil arrangement 13, the driving force F increases gradually up to a maximum, as long as the rotor 2 is still located in the interaction ranges of all coils of the left coil arrangement 13. In the meantime, the rotor 2 gradually enters the interaction ranges of all coils of the right coil arrangement 13. As long as the rotor 2 is located in the interaction ranges of all coils of the left and the right coil arrangements 13, 13, the driving force F of the linear motor 1 remains constant. When the rotor 2 continues to move and leaves more and more interaction ranges of coils of the left coil arrangement 13, the driving force F of the linear motor 1 drops. When the rotor 2 leaves the interaction range of the left coil arrangement, and is still located in the interaction ranges of all coils of the right coil arrangement 13, the driving force F of the linear motor 1 remains essentially constant. With a continuous movement, the rotor 2 leaves more and more interaction ranges of coils of the right coil arrangement 13, resulting in a drop of the driving force F.

As can be seen in the diagram illustrated in FIG. 3A, the curve of the driving force F has an asymmetric shape with regard to the travel distance covered s of the rotor 2. In the area of an ascending branch of the curve, the driving force F, with regard to a section of the travel distance covered s of equal length, changes more than in an area of a descending branch of the curve.

FIG. 3B shows the arrangement of FIG. 3A with the difference that the stator modules 11, 11 are disposed at a distance to each other. The rotor 2 has preferably a length, which is equal to a sum of lengths of the left and the right coil arrangements 13, 13, a length of a displacement sensor 12 of the left stator module 11, as well as of a distance of the stator modules 11, 11 to each other. When the rotor 2 moves, it is already in interaction ranges of all coils of the left coil arrangement 13. Initially, the rotor 2 remains in interaction ranges of all coils of the left coil arrangement 13, resulting in a constant driving force F of the linear motor 1. When the rotor 2 starts to enter interaction ranges of coils of the right coil arrangement 13, the rotor 1 leaves interaction ranges of coils of the left coil arrangement 13 to the same extent, such that the driving force F of the linear motor 1 continues to remain almost constant. When the rotor 2 continues to move, it gradually leaves interaction ranges of coils of the right coil arrangement 13, which results in a drop of the driving force F of the linear motor 1.

In this arrangement it is therefore possible, with a comparatively long, maximally possible travel path, to realize an almost constant driving force F of the linear motor 1 over a large portion of the travel path.

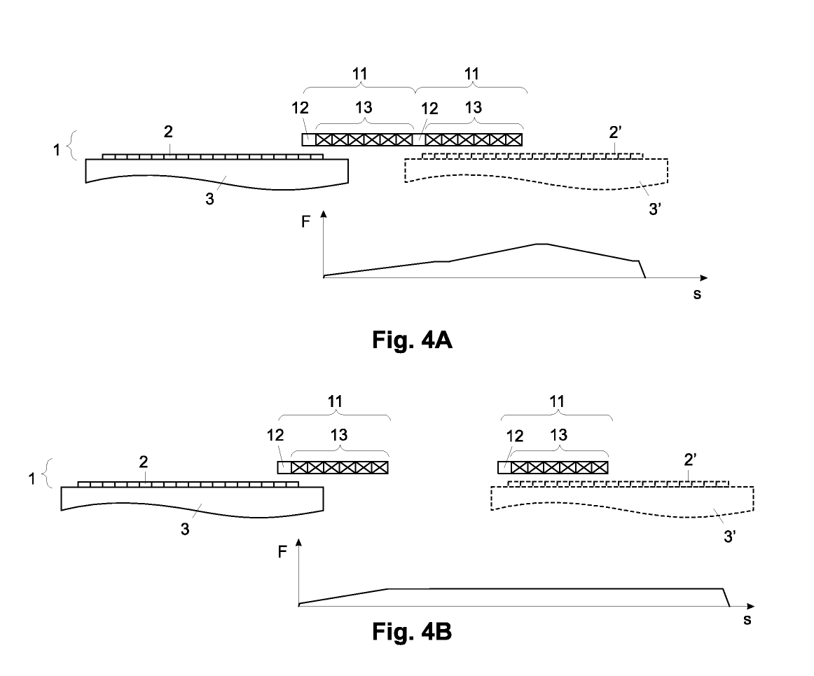

The arrangements shown in FIGS. 4A and 4B differ from those illustrated in respectively FIGS. 3A and 3B in that the coil arrangements 13, 13 and the respective displacement sensors 12 are disposed in an opposite direction. This means, instead of being disposed at the respective right end, the displacement sensors 12, 12 in FIGS. 4A and 4B are disposed at the respective left ends of the respective stator modules 11, 11. With regard to the embodiment according to the FIGS. 4A and 4B, the characteristic of the driving force F of the linear motor 1 is respectively mirror-inverted comparing to those of the driving force F for the embodiment of FIGS. 3A and 3B.

Thus, the above described arrangements of stator modules 11 allow for realizing different driving force characteristics.

Arrangements of stator modules 11, 11 are shown in the Figures, which respectively illustrate the characteristic of the respective driving force F of the linear motor 1 between respective maximally possible terminal positions of the rotor 2. Obviously a control circuit 20 may be provided for the linear motor 1, by means of which the actual terminal positions are offset, which results in cutting off the curve of the driving force F of the linear motor 1 at predetermined locations on the s-coordinate axis in the diagrams of the Figures.

Instead of one type of stator modules 11, 11, obviously different stator modules 11, 11 may be provided, i.e. stator modules 11 with different coil arrangements 13, 13. The coil arrangements 13, 13 of the individual stator modules 11, 11 may have different lengths, i.e. have different numbers of coils.

In addition, the windings of the coils may be different. The coils may be without a winding, for example, or they may be missing completely, such that the respective coil arrangement 13 has gaps.

In addition, at least one stator module 11 may have respectively one displacement sensor 12 at both ends, which, with regard to this stator module 11, results in a driving force characteristic according to FIG. 2A.

Should the linear motor 1 have more than two stator modules 11, 11, all conceivable combinations of the shown arrangements of respectively two stator modules 11, 11 to each other are possible. The respective selected combination merely depends on the desired characteristic of the driving force F of the linear motor 1.

The linear motor 1 has been described above on the understanding that the coil arrangements 13, 13 of the at least two stator modules 11 are constantly energized. However, a coil arrangement 13, which is in no-load operation, i.e. when the rotor 2 is not located to a predetermined extent in the interaction range of the respective coil arrangement 13, is a pure waste of energy. Likewise, on account of the no-load operation and of the subsequently rising current in the respective coil arrangement, damage might be caused by means of heat development in this coil arrangement. In addition, on account of the high current demand, a relatively large sized power supply unit is required, not saying anything about the waste of energy.

Therefore, the linear motor 1, according to an advantageous further development, furthermore has a control circuit 20 which is coupled to the at least two stator modules 11, 11 and is adapted to detect, respectively to read detection signals of the displacement sensors 12, 12. Based on the detection signals, the control circuit 20 determines a position of the at least one rotor 2 with regard to the stator 10 and controls the coil arrangements 13, 13 of the at least two stator modules 11, 11 according to the detected position of the rotor 2.

Preferably the control circuit 20 is adapted to switch-off individually each coil arrangement 13 of the at least two stator modules 11, 11, if the control circuit 20 detects that the rotor 2, at the determined position of the rotor 2, falls below a predetermined first penetration measure into a predetermined section of the interaction range of a respective coil arrangement 13. This helps to avoid unwanted no-load operations of the respective stator module 11 and prevents damages. Furthermore, therefore a comparatively smaller power supply unit can be used, which helps to save costs. In addition, switching-off may be used to adapt the curve of the driving force F of the linear motor 1 to predetermined requirements. For example in the arrangement shown in FIG. 1A, an automatic shut-off system may prevent the driving force F from rising to the maximum value, as is shown in the middle of the diagram, and/or reduce the maximum value of the driving force F.

Furthermore, the control circuit 20 may be adapted to switch-off at least one coil arrangement 13 of one of the at least two stator modules 11, 11, if the control circuit determines that the determined position of the rotor 2 corresponds to a terminal position of the at least one rotor 2. This is in particular useful with revolving travel paths, in which the terminal positions can not be defined by means of the stator modules 11, 11. A second application case is if the actual terminal position does not correspond to a maximally possible terminal position. In the arrangement shown in FIG. 2A, it may be the case for example that the driving force F is too low at the beginning of a movement of the rotor 2. In order to change this situation, the terminal positions in FIG. 2A are moved towards each other, which, according to the curve of the driving force F of the linear motor 1 illustrated in the corresponding diagram, translates to a larger initial and terminal driving force.

In addition, it is furthermore preferred the control circuit 20 is adapted to additionally switch-on at least one coil arrangement 13 of one of the at least two stator modules 11, 11, if the control circuit 20 determines that the rotor 2, at the determined position of the rotor 2, has reached or exceeded a predetermined second penetration measure into a predetermined section of the interaction range of a respective coil arrangement 13. This serves the purpose of supplying a switched-off coil arrangement 13 with current, in order to guarantee a further movement of the respective rotor 2.

Preferably the first and the second penetration measures are equal.

The arrangements illustrated in the Figures respectively represent extreme situations, i.e. stator modules 11, 11 with no distance or at maximum distance to each other. Additional possible distances between the stator modules 11 are conceivable.

In case of such smaller distances, the described automatic shut-off and additional switch-on systems by means of the control circuit 20 are very practical. In an arrangement according to FIG. 1D, it is possible for example, with smaller distances between the stator modules 11, 11, to reach an almost constant curve of the driving force F of the linear motor 1. Furthermore, a smaller distance between the stator modules 11, 11 makes it possible to configure a respective shorter rotor 2, which helps to save material and, in particular with high performance magnets, to save costs. The respective rotor 2 does not necessarily have to be configured to extend over the entire width of the panel to be moved 3.

In addition, a distance between two directly adjacent stator modules 11, 11 offers space for additional devices, such as a smoke detector sensor system.

Likewise, the here described rotor 2, as long as it has permanent magnets, may be configured so that the rotor 2 has gaps in the row of permanent magnets, which gaps might be filled with intermediate pieces made from magnetizable material.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A linear motor comprising:
a stator having at least two stator modules, each of the at least two stator modules having a coil arrangement and, in a longitudinal extension of the respective stator module, a displacement sensor at least at one end of the coil arrangement; and
at least one rotor;
wherein each of the at least two stator modules is disposed along a travel path of the rotor in an area of the travel path;
wherein each of the displacement sensors has respectively a detection range, within which the each of the displacement sensors can detect the at least one rotor as long as a section of the at least one rotor is located in the respective detection range,
wherein each of the coil arrangements has respectively an interaction range, within which the each of the coil arrangements, in case of energizing, interacts with the at least one rotor and urges the latter into a driving direction, as long as a section of the at least one rotor is located in the respective interaction range, and
wherein the at least two stator modules and the at least one rotor are disposed and configured such that, at all times, one portion of the at least one rotor is located in the detection range of at least one of the displacement sensors and another portion of the at least one rotor is located in the interaction range of at least one of the coil arrangements.

12. The linear motor according to claim 11, wherein two directly adjacently disposed stator modules of the at least two stator modules, with regard to an orientation of the respective displacement sensors, are disposed with regard to each other, according to a length of the at least one rotor, according to a travel path of the at least one rotor and according to a predetermined characteristic of a driving force (F) of the linear motor depending on a travel distance covered (s) of the at least one rotor.

13. The linear motor according to claim 12, wherein the respective displacement sensors of the at least two directly adjacently disposed stator modules face each other.

14. The linear motor according to claim 12, wherein the two directly adjacently disposed stator modules of the at least two stator modules have a distance to each other according to the length of the at least one rotor, according to the travel path of the at least one rotor, and according to the predetermined characteristic of the driving force (F) of the linear motor depending on the travel distance covered (s) of the at least one rotor.

15. The linear motor according to claim 11, wherein the displacement sensors are formed by Hall sensors.

16. The linear motor according to claim 11, further comprising a control circuit coupled to the at least two stator modules for receiving respective detection signals of the displacement sensors,
wherein the control circuit is operable to determine a position of the at least one rotor with regard to the stator and to control the coil arrangements of the at least two stator modules according to the determined position of the at least one rotor.

17. The linear motor according to claim 16, wherein the control circuit is operable to switch-off at least one of the coil arrangements of the at least two stator modules, if the control circuit determines that the determined position of the at least one rotor falls below a predetermined first penetration measure of the at least one rotor into a predetermined section of the interaction range of the at least one of the coil arrangements.

18. The linear motor according to claim 16, wherein the control circuit is operable to switch-off at least one coil arrangement of one of the at least two stator modules, if the control circuit determines that the determined position of the at least one rotor corresponds to a predetermined terminal position of the at least one rotor.

19. The linear motor according to claim 17, wherein the control circuit is operable to switch-on at least one of the coil arrangements of the at least two stator modules, if the control circuit determines that the determined position of the at least one rotor corresponds to a predetermined second penetration measure of the at least one rotor into the interaction range of the at least one of the coil arrangements or exceeds the predetermined second penetration measure.

20. The linear motor according to claim 19, wherein the first and second penetrations measures are equal.

21. The linear motor according to claim 13, wherein the two directly adjacently disposed stator modules of the at least two stator modules have a distance to each other according to the length of the at least one rotor, according to the travel path of the at least one rotor, and according to the predetermined characteristic of the driving force (F) of the linear motor depending on the travel distance covered (s) of the at least one rotor.

22. The linear motor according to claim 12, wherein the displacement sensors are formed by means of Hall sensors.

23. The linear motor according to claim 13, wherein the displacement sensors are formed by means of Hall sensors.

24. The linear motor according to claim 14, wherein the displacement sensors are formed by means of Hall sensors.

25. The linear motor according to claim 12, further comprising a control circuit coupled to the at least two stator modules for receiving respective detection signals of the displacement sensors,
wherein the control circuit is operable to determine a position of the at least one rotor with regard to the stator and to control the coil arrangements of the at least two stator modules according to the determined position of the at least one rotor.

26. The linear motor according to claim 13, further comprising a control circuit coupled to the at least two stator modules for receiving respective detection signals of the displacement sensors,
wherein the control circuit is operable to determine a position of the at least one rotor with regard to the stator and to control the coil arrangements of the at least two stator modules according to the determined position of the at least one rotor.

27. The linear motor according to claim 13, further comprising a control circuit coupled to the at least two stator modules for receiving respective detection signals of the displacement sensors,
wherein the control circuit is operable to determine a position of the at least one rotor with regard to the stator and to control the coil arrangements of the at least two stator modules according to the determined position of the at least one rotor.

28. The linear motor according to claim 17, wherein the control circuit is operable to switch-off at least one coil arrangement of one of the at least two stator modules, if the control circuit determines that the determined position of the at least one rotor corresponds to a predetermined terminal position of the at least one rotor.

29. The linear motor according to claim 16, wherein the control circuit is operable to switch-on at least one of the coil arrangements of the at least two stator modules, if the control circuit determines that the determined position of the at least one rotor corresponds to a predetermined second penetration measure of the at least one rotor into the interaction range of the at least one of the coil arrangements or exceeds the predetermined second penetration measure.

30. The linear motor according to claim 18, wherein the control circuit is operable to switch-on at least one of the coil arrangements of the at least two stator modules, if the control circuit determines that the determined position of the at least one rotor corresponds to a predetermined second penetration measure of the at least one rotor into the interaction range of the at least one of the coil arrangements or exceeds the predetermined second penetration measure.
